(19) United States
(12) Patent Application Publication
(10) Pub. No.: US 2008/0133290 A1
(43) Pub. Date: Jun. 5, 2008

(54) System and method for analyzing and presenting physician quality information

(76) Inventors: Richard B. Siegrist, Acton, MA (US); William Kleinfelter, Ivyland, PA (US); Donald Siegrist, Harvard, MA (US); Brian Gambs, Somerville, MA (US)

Correspondence Address: WILMERHALE/BOSTON, 60 STATE STREET, BOSTON, MA, 02109, US

(21) Appl. No.: 11/644,577

(22) Filed: Dec. 22, 2006

Related U.S. Application Data
(60) Provisional application No. 60/868,521, filed on Dec. 4, 2006.

(51) Int. Cl. G06F 9/44

(52) U.S. Cl. 705/7

(57) ABSTRACT

Systems and methods for compiling and presenting physician quality information to consumers are provided. The physician quality information system aggregates data from data sources such as claims data, patient satisfaction data, and public discharge data and computes metrics based on definitions. These metrics can be things such as mortality rate, patient wait time after the scheduled appointment, and whether a physician performed a certain test when a specified set of symptoms were present. The consumer is presented with the physician quality information system through a website. The consumer can enter his or her preferences regarding the physician search into the website and these preferences are used to customize the report that is generated from the information that is computed and complied by the physician quality information system.

### CROSS-REFERENCE TO RELATED APPLICATIONS

This application is related to U.S. Provisional Application No. 60/868,521, entitled “Method and System For Use of a Health Profile With Health-Related Information Tools”, filed Dec. 4, 2006, and is hereby incorporated by reference herein in its entirety. This application is also related to U.S. patent application Ser. No. 11/566,286, filed on Dec. 4, 2006, entitled “Method and System For Optimizing Fund Contributions to a Health Savings Account,” and is hereby incorporated by reference herein in its entirety.

### FIELD OF THE DISCLOSURE

The present invention relates to a system and method for processing and presenting physician quality information to consumers. More particularly, consumers can compare physician quality using a variety of information and receive comparisons based on the consumer's preferences.

### BACKGROUND OF THE DISCLOSURE

Increasingly consumers are faced with decisions regarding the selection of a physician for their health care needs. For example, when a consumer changes health insurance coverage, typically, the consumer also needs to change his or her physicians to ones covered by the new insurance plan. Generally, the consumer is provided little to no information with which to make a selection of what doctor would best meet the consumer's needs. Much of the information regarding doctors is not compiled in a format that consumers can access and use to make an informed decision. Another problem facing consumers is that there is no way to make meaningful comparisons between physicians when there is data on physicians. Additionally, the consumer has little to no input on what aspects of the data are important to him or her.

### SUMMARY OF THE DISCLOSURE

The physician quality information system provides members of a health plan or consumers with a meaningful and sound approach to evaluating physician performance. Physicians are compared to patient specific benchmarks derived from publicly available data and/or health plan claims data for measuring process performance, outcome, and satisfaction information. The consumer using the physician quality information system is presented with a customized report tailored to the consumer's preferences and selections. The physician quality information system also allow consumers to compare a plurality of physicians on a number of definable metrics. Where the metrics can be defined according to an administrator's or other user's interests.

Health plans may use the results of this physician performance benchmarking to: define physician networks; place physicians into performance tiers; develop physician pay-for-performance programs; negotiate with physicians; identify potential quality improvements and cost savings from network modifications; and undertake other benchmarking related initiatives.

Historically, physician benchmarking has been problematic because of small cell size issues, the lack of meaningful quality metrics, and the absence of benchmarks that are tailored to a specific physician's actual patient severity. The physician quality information system can address these issues by: reducing the impact of small cell size issues by applying individual patient benchmarks for each physician; encompassing as wide or narrow a range of case types as desired for analysis; tailoring benchmarks to health plan's specific needs for a particular initiative; addressing physician concern that their patients are “sicker” by developing benchmarks at the individual severity level within a diagnostic related group (DRG); developing and applying benchmarks separately for each quality and cost metric; and creating meaningful physician comparative information for a wide variety of analyses.

In one aspect, a method is provided for obtaining from one or more data sources data about health care that was provided by a plurality of physicians; from the data, computing a set of metrics for the plurality of physicians; receiving preferences that are specified by a consumer, the preferences identifying physician attributes that are desired by the consumer; deriving from the specified consumer preferences a set of weights for the set of metrics; and for a group of physicians that is selected by the consumer from among the plurality of physicians, computing a ranking of those physicians based upon the computed set of metrics and the derived set of weights.

In another aspect, a method is provided for receiving a consumer selection of a geographic location and at least one of a physician type and a medical procedure; displaying a list of physicians based on the consumer selection; receiving preferences that are specified by a consumer, the preferences identifying physician attributes that are desired by the consumer; and for a group of physicians that is selected by the consumer from among the plurality of physicians, displaying a report that presents metrics on the group of physicians, presents a summary of a group of metrics in a category, and presents an overall ranking of the group of physicians customized to the preferences specified by the consumer.

In yet another aspect, a system is provided with a claims database and a public discharge database; a quality rules application engine in communication with the claims database and the public discharge database, wherein the quality rules engine computes a set of metrics for the plurality of physicians; a consumer preferences module that receives consumer preferences, the preferences identifying physician attributes that are desired by the consumer, and that derives from the specified consumer preferences a set of weights for the set of metrics; and a physician quality website that displays a ranking of those physicians based upon the computed set of metrics and the derived set of weights for a group of physicians that is selected by the consumer from among the plurality of physicians.

In yet another aspect, a system is provided with a means for providing a data source; means for providing an engine in communication with the means for providing a data source, wherein the means for providing an engine computes a set of metrics for the plurality of physicians; consumer preferences means for receiving consumer preferences, the preferences identifying physician attributes that are desired by the consumer, and for deriving from the specified consumer preferences a set of weights for the set of metrics; and means for displaying a ranking of those physicians based upon the computed set of metrics and the derived set of weights for a group of physicians that is selected by the consumer from among the plurality of physicians.

### BRIEF DESCRIPTION OF THE DRAWINGS

FIG. 1 shows a block diagram representation of a physician quality information system;

FIG. 2 shows an information screen of the physician quality information system;

FIG. 3 shows a screen for choosing physicians in the physician quality information system;

FIG. 4 shows a consumer preferences screen in the physician quality information system;

FIG. 5 shows a physician ranking screen for inpatient outcomes for physicians in the physician quality information system;

FIG. 6 shows a summary ranking screen for inpatient outcomes for physicians in the physician quality information system;

FIG. 7 shows a hospital comparison screen;

FIG. 8 shows a block diagram representing how a physician quality report can be generated;

FIG. 9 shows a block diagram representing how a database can be loaded; and

FIG. 10 shows a block diagram representing how an algorithm for obtaining a metric and how the rankings can be implemented.

### DETAILED DESCRIPTION OF SOME EMBODIMENTS

The described embodiment relates to providing consumers with physician quality information. In the described embodiment, a physician quality information system includes a web interface for consumers to input preference and selection information as well as computer-processed algorithms for aggregating and processing a variety of information according to consumer preferences. Three categories of information can be used for analyzing a physician's quality, which include: inpatient outcomes for a physician; physician process performance measurements; and patient satisfaction with a physician. In each category, consumer preferences are used to rank physicians according to what the individual consumer values. An overall ranking based on the three categories is also calculated. The physician quality information system provides consumers with dynamic reporting tailored to their interests. The reports that are generated further allow a consumer to drill down in each category and metric to see quantitative comparisons between physicians.

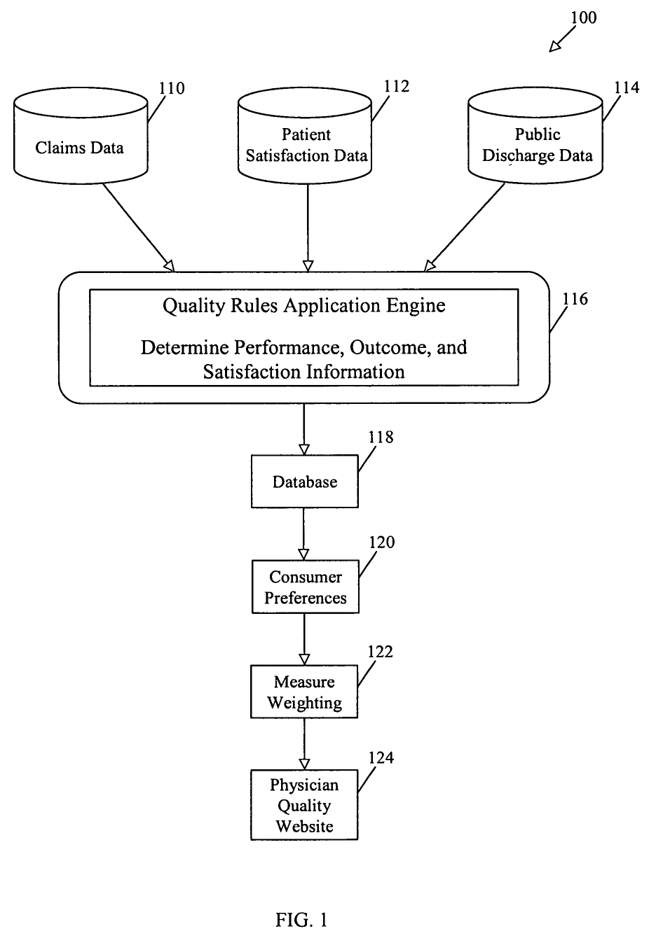

FIG. 1 depicts a block diagram representation of a physician quality information system 100. The physician quality information system 100 draws information from a number of databases that include claims data 110, patient satisfaction data 112, and public discharge data 114. The claims data 110 includes medical claims information for a number of patients and includes any treatments and resources used by a physician in providing care to the patient. Other information, such as whether there were complications or a mortality as a result of the treatment, may also be included. The patient satisfaction data 112 is a collection of patient surveys that rate a patient's satisfaction with a physician. The public discharge data 114 includes outcome information from inpatient events such as complications, mortalities, and length of stay. These three data sources: claims data 110, patient satisfaction data 112, and public discharge data may not be in a suitable form for collecting information for physicians. This may be because the data includes information that is irrelevant or because the data was intended possibly for other purposes such as receiving payment for services.

The physician quality information system 100 uses a load process in combination with the data sources and a quality rules application engine 116 to compile and compute data from the data sources into a database 118. The load process includes filtering the data to remove data from the data sources that does not meet defined standards, and then drawing data from the data sources that is used for building defined metrics. A quality rules application engine 116 accesses the data source databases and runs algorithms on the data to process and to compile the available data into metrics for each physician. These metrics are defined or chosen from published metrics by an administrator or other person and the metrics relate to the information that is computed for the physicians from the data sources.

The quality rules application engine 116 is programmed to perform process performance, patient satisfaction, and outcomes computations. The process performance metrics are based on definitions set by one or more industry groups or associations for measuring physician performance. An example of such a group is the American Quality Alliance (AQA), which is a coalition that devises peer ratings to measure physician performance (see Appendix A). Patient satisfaction metrics are defined on what information is desired for compiling and computing from a patient satisfaction survey. An example of a survey is provided in Appendix B. The outcomes metrics are based on information regarding events that occur or resources that are used such as computing a mortality rate, an average length of stay, a complications rate, and/or an average cost. A group of metrics can be grouped into a category.

The metrics after being compiled and/or computed are loaded from the quality rules application engine 116 to database 118. Database 118 stores the compiled information for each physician. The compiled information stored in database 118 is condensed by eliminating information that is not relevant for computing the metrics and by matching the disparate forms of data to the physician with which the data is associated.

A consumer preferences module 120 solicits preference and selection information from a consumer which is used to determine the report that is generated. The consumer preferences module 120 also retrieves information from database 118 to present the consumer with an initial list of physicians from which to select. From these selected physicians a report is generated. The consumer preferences are obtained by providing the consumer with choices to personalize how the physician quality information is output. The consumer preferences adjust how the summary level rankings are determined as well as the geographical area and type of physician/medical procedure for which a report is generated. These consumer preferences regarding adjustments use algorithms that adjust the relative important of different metrics or categories based on preferences obtained from the consumer.

A metric weighting module 122 receives the weighting factors drawn from consumer preferences and adjusts the metrics from database 118 according to consumer preferences as well as performing standardizing adjustments. First the weighting module 122 performs calculations to provide adjustments to the metrics to standardize the physician rankings and summary level information in response to a consumer query. An example of this standardization is adjusting for the severity of the patients seen by a physician, so physicians receive credit for keeping high risk patients alive. Second the weighting module 122 uses weighting factors derived from consumer preferences to compile a ranking for each category (e.g., performance, outcome, and satisfaction information) and to compile the categories into overall ranking of the physicians based on each category. Because the ranking is based on the consumer preferences, the report generated is a function of the consumer's interests. Thus, consumers searching for physicians in the same area receive lists tailored to their preferences. The compiled and computed information is presented to the consumer through a physician quality website 124. The physician quality website 124 allows the consumer to input his or her preferences and explore the reports generated by the physician quality information system.

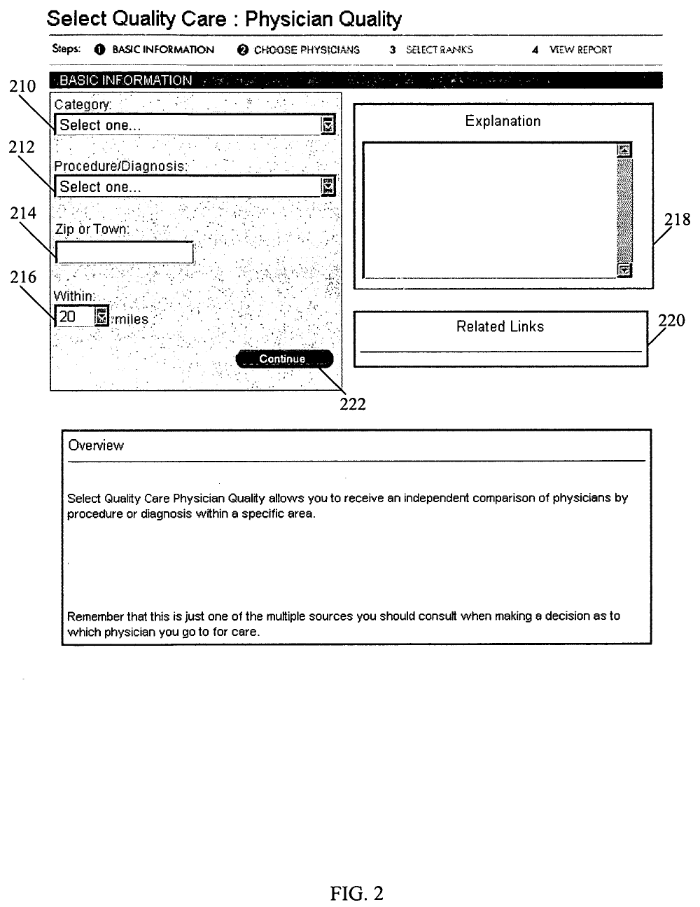

The physician quality website 124 includes a basic information screen as shown in FIG. 2. The basic information screen is used to obtain consumer selection information from the consumer. This consumer selection information narrows a physician search to a geographical area and to a particular category of physicians or to a particular procedure/diagnosis that physicians perform. This limits the data search and pull from database 118. The consumer uses a category menu 210 to select physician specialties available for comparison. Examples of physician specialties are general surgery, oncology, pediatrics, cardiology, internal medicine, and orthopedics. A procedure/diagnosis menu 212 provides the consumer a drop down selection of procedures such as open-heart surgery, hip replacement, cesarean section as well as diagnosis such as diabetes, pneumonia, and congestive heart failure. A zip code or town field 214 in conjunction with a miles menu 216 limits the physician comparison to a geographical area of interest. An explanation area 218 provides consumers with additional information about the consumer's category or procedure/diagnosis selection and related links 220 are provided for additional information, if available.

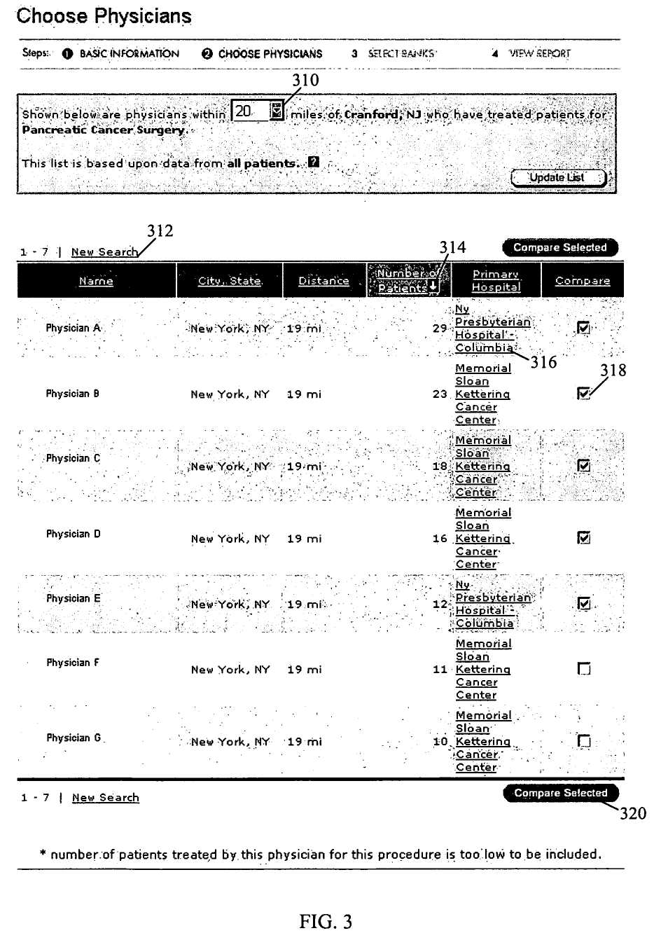

A continue button 222 brings a consumer to another screen, which presents a physician listing as shown in FIG. 3. After clicking the continue button 222, the information entered in menus 210, 212, 214, and 216 is used to query the database 118 for matching physicians. A physician list screen provides preliminary information about the physicians pulled from database 118 and allows a consumer to select which physicians that the consumer would like to compare. A mileage menu 310 is provided to change the geographical area included for the selection of physicians in FIG. 3. If a consumer finds that there are too few physicians or too many physicians in the list for the selected area, the consumer can use the mileage menu 310 to change the geographical area. If the mileage menu 310 is changed, database 118 is re-queried and another physician list screen is displayed modifying the physician list size. Similarly, a new search link 312 allows a consumer to restart the physician search. A sort arrow 314 is provided in the physician list so that the consumer can organize the physician list as he or she wishes. A hospital link 316 provides additional information regarding the hospital the physician is associated with such as the hospital's accreditation status, the hospital's address, and the hospital's specialties. The consumer uses a compare box 318, which is associated with a physician, to indicate a desire to compare that physician to other physicians or to receive additional information on that physician alone.

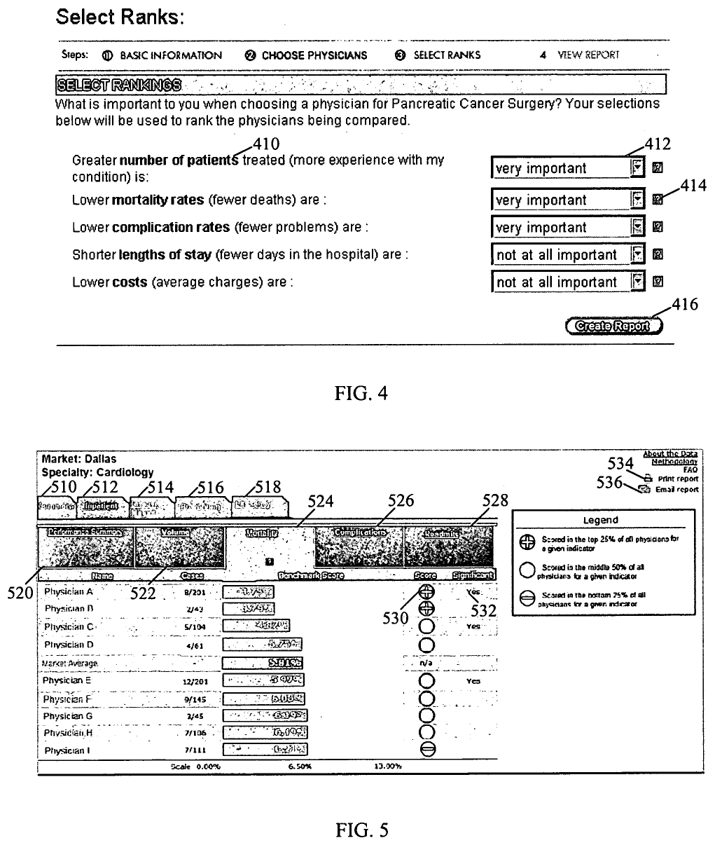

A “compare selected” button 320 brings the consumer to another screen that includes a selection of consumer preferences as shown in FIG. 4. A statement 410 provides an area of specificity regarding the report generation that a consumer can rank using ranking menu 412. The ranking menu 412 provides levels of importance to a consumer so that the consumer can specify how important the different statements 410 are. The preferences displayed to the consumer in ranking menu 412 can be very important, somewhat important, not very important, or not at all important. The statements the consumer ranks with the ranking menu 412 include statements regarding both the category and the metric that are reported. An information box 414 provides a consumer with more information regarding the statement 410 and what the statement includes. The consumer preferences are used to sort/rank the physicians for the report and are input into consumer preferences module 120 to customize the report. The consumer preferences module 120 receives the consumer preferences (FIG. 4), pulls the information on the selected physicians 318 (FIG. 3) from database 118, and sends the consumer preferences to the weighting module 122 for algorithm calculation. (The algorithms are described in greater detail below.) A create report button 416 begins the analysis of the data of the selected physicians to sort them according to the consumer's preferences.

The report that is created allows consumers to navigate through comparisons of the physicians down to specific metrics such patient mortality as shown in FIG. 5. The report includes a tab for summary level information for a category, such as outcomes. Other tabs include detailed metric information in the outcomes category. Inpatient tab 512, disease management tab 514, prevention tab 516, and efficiency tab 518 include metric information relating to the tab. The consumer can drill down into specific metric information by selecting a tab and then selecting a metric. The metrics and summary tab shown in FIG. 5 include performance summary 520, volume 522, mortality 524, complications 526, and re-admissions 528. The performance summary tab is a summary of the inpatient metrics. The volume metric 522 is the number of patients the physician has seen during a specified time period. The mortality metric 524 is the number of deaths per the number of patients under the care of the physician. The complications metric 526 is the number of complications per patients. The re-admits metric 528 is the number of patients that had to be re-admitted to the hospital within a specified amount of time after release.

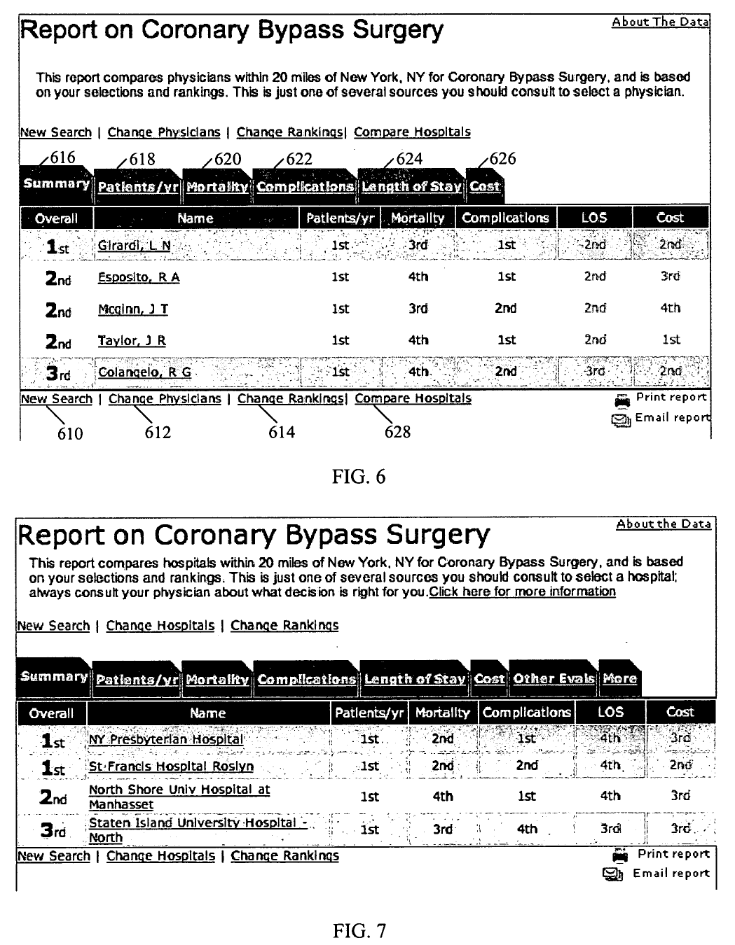

In FIG. 5, the inpatient tab 512 provides the consumer with detailed metrics and specifically a mortality metric 524 is shown. The metrics give the sample size, the benchmark score, the quartile ranking, and statistical significance indicator. A score icon 530 indicates what percentile group the physician ranked in and the statistically significant indicator 532 indicates when the information is statistically significant. The print report option 534 allows the consumer to print a paper copy of the report generated based on his or her preferences. The email report option 536 allows the consumer to send the report to an email address. The reports generated can display information for a particular type of specialty or a particular type of procedure. The FIG. 5 screenshot shows a report for cardiologists (a specialty report), while the FIG. 6 screenshot shows a report for coronary bypass surgery (a procedure/diagnosis report).

FIG. 6 further illustrates a category ranking screen of a report for a selected physician list. In FIG. 6, the outcome category and the metrics included in that category are shown. The screen provides links to allow a consumer to modify his or her choices in generating the report. The consumer can conduct a new search by selecting a new search link 610, which allows the user to restart the process. The consumer can change the physicians that he or she originally selected to compare by selecting a change physicians link 612. The consumer can change the preference information regarding what is important to him or her by selecting a change rankings link 614.

The tabs of FIG. 6 allow the consumer to drill down into the various metrics. The summary tab 616 illustrates the rankings for the outcomes category. Other categories can also be displayed in a similar fashion. The physicians for the category are ranked according to consumer preferences, for example, patients/yr, mortality, and complications. While length of stay (LOS) and cost are included in the summary ranking, they are not included in determining the physician's rank in the list (they were given a preference of not important at all). The tabs 618, 620, 622, 624, and 626 provide detailed information regarding those metrics. The category ranking screen provides a compare hospitals link 628 to a hospital comparison screen, where the hospitals with which the physicians are associated are ranked as shown in FIG. 7.

FIG. 7 shows a hospital comparison screen. The hospital comparison screen displays rankings of the hospitals associated with the physicians of FIG. 6. The physician quality information system can exchange the information generated or obtained for a consumer with other tools. For example, the information of the physicians selected and other consumer preferences are integrated into the hospital comparison tool. Additionally, the WebMD Health Savings Account optimizer tool or the WebMD master profile can use information generated by the physician quality information system. The WebMD Health Savings Account optimizer tool is further described in a related patent application incorporated above and entitled “Method and System For Optimizing Fund Contributions to a Health Savings Account.” The WebMD master profile is further described in a related patent incorporated above and entitled “Method and System For Use of a Health Profile With Health-Related Information Tools.” The WebMD Health Savings Account optimizer tool can use the physician selections, length of stay, and cost information to assist in more accurate estimations of health care expenses.

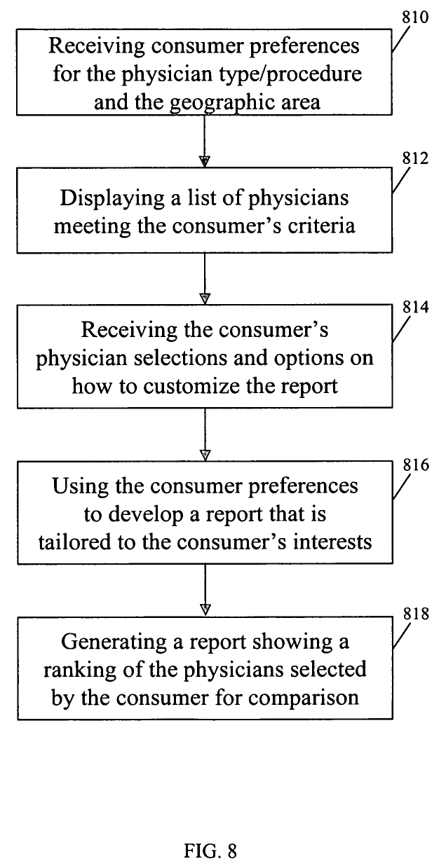

FIG. 8 illustrates a block diagram representing how a physician quality report can be generated. In step 810, the physician quality information system receives the consumer selections from the consumer accessing the website for the physician type (e.g., oncologist, cardiologist, orthopedist, cardiac surgeon, etc.) or procedure (open heart surgery, brain surgery, chemotherapy, etc.) and the geographic location. The physician quality information system uses this information to display a list of physicians that meet the consumer's selection criteria in step 812. The consumer reviews the physician list and decides which physicians he or she would like to further investigate and compare. In step 814, the consumer makes the physician selections and also decides on a number of consumer preferences. These consumer preferences include things such as what types of information are important to him or her as well as whether to evaluate for patients of a particular demographic or to benchmark the physicians for a specific procedure, for example. Other aspects of consumer preference options are described below. The physician quality information system uses the consumer preferences to develop a report that is tailored to the consumer's interests, in step 816, by performing weighting calculations and specifying the data set used to generate the report. In step 818, a report is generated showing a raking of the physicians selected by the consumer for comparison. The report is interactive and multi-tiered.

At the top most tier, an overall ranking of the physicians is given. This overall ranking includes the physicians ranked according to their performance in each of the categories. At an intermediate tier, a ranking of the physicians is provided for each of the categories (e.g., performance, outcome, and satisfaction categories). The consumer can navigate to view the summaries of the metrics in each of the categories at a lower tier. The consumer preferences are used to influence the rankings by weighing the metrics and/or categories according to the consumer's interests. Navigation in the physician quality information system between the top most tier, the intermediate tier, and the lowest tier is accomplished by tabs. A summary tab can be used to display top tier overall ranking information. To the right of this summary tab, the category tabs are placed. When a consumer wishes to view a category they click on the category tab of interest. This action changes the display screen to show the physician rankings according to the category metrics. The action also populates a menu bar below the category tabs with a set of metric tabs. If the user clicks on one of the metric tabs, the information pertaining to that metric is displayed.

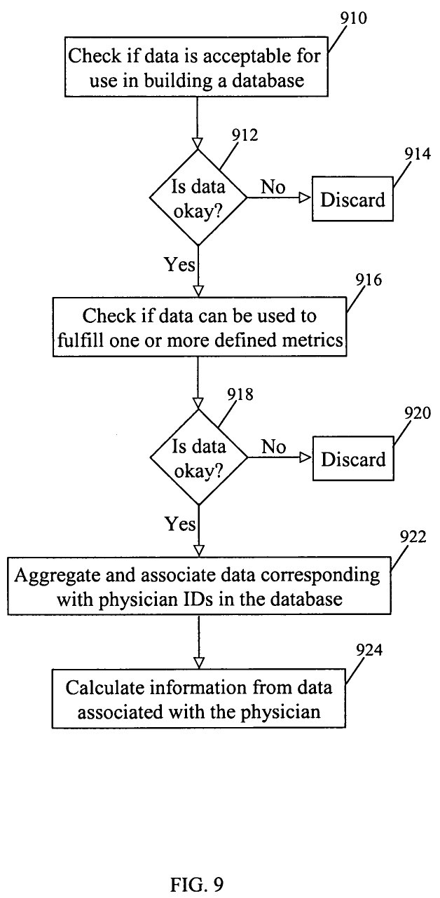

FIG. 9 illustrates an algorithm implemented by the physician quality information system to build database 118. In step 910, the physician quality information system checks if data in at least one of claims data 110, patient satisfaction data 112, public discharge data 114, or any other user defined database is acceptable for use in building a database. The check can involve validating completeness of the data, checking for errors, omissions, or other inconsistencies, and flagging data that looks suspicious (e.g., medical treatments that do not make sense together). If the data does not check out at step 912, then the data is discarded from being used in the compilation. If the data checks out at step 912, then the data is checked by the quality rules application engine 116 to see if the data can be used for at least one the defined metrics in the physician quality information system in step 916. Because the definitions of the metrics can be changed, this check removes information that is not viewed as relevant or desirable for display to a consumer. A data check is performed against the metrics to see if any of the data is applicable for use in compiling one or more metrics for a physician. This is performed because the physician quality information system can be flexibly programmed with different metrics for comparison or the definition of a metric can change. If the data cannot be used in step 918, then the data is discarded in step 920. If the data can be used, then the data is aggregated together and associated with a physician ID in the database at 922. In the database, the physician ID is used to represent a physician and a name is associated with this ID. In step 924, the data associated with a physician is then calculated to develop attributes regarding the physician, such as the number of patients that are included for that physician, mortality rate, complication rate, and what type of procedures the physician performed.

The quality rules engine 116 performs certain manipulations of the data obtained from the claims data 110, the patient satisfaction data 112, and the public discharge data 114 in addition to the functions mentioned above. Severity adjustment is one type of manipulation that is performed. Severity adjustment provides for standardizing of the benchmarks for the physicians. The quality rules engine 116 addresses common physician concerns by applying a benchmark relevant for each specific patient based on that patient's diagnostic related group (DRG) and severity level within that DRG. Accordingly, a patient with more severe congestive heart failure (CHF) has a different benchmark than a patient with less severe CHF.

There are at least two possible choices for the severity adjustment used in the physician quality information system: All Patient Refined Diagnosis Related Groups (APR-DRGs) from 3M or Refined Diagnosis Related Groups (RDRGs) developed at Yale. User defined severity adjustments may also be used. For the APR-DRGs, the severity of illness score or APR-DRG S is used for resource use metrics (e.g., length of stay, cost) while the risk of mortality score or APR-DRG M is used for quality metrics (e.g., mortality, failure to rescue, complications). For the RDRGs, the regular RDRG is used for resource use metrics while an Adjusted RDRG (ARDRG) as developed by WebMD Quality Services is used for quality metrics. Regardless of the system that is used, the same severity adjustment approach can be applied as described below.

There are two severity adjustment approaches that can be used for comparing physician performance. A first approach is an indirect standardization approach that is used for category tier summary level calculations and overall top tier summary ranking. The second approach is a direct standardization approach that is used for metric level comparison, for example, comparing mortality rates between physicians. A physician's actual performance on a metric is the unadjusted rate. For example, if the physician saw 50 patients and 2 died, the actual rate would be 2/50 or 4%. If 40 of those patients were in the population at risk for post-op pulmonary embolism/deep vein thrombosis (PE/DVT) and 1 had a PE/DVT, the actual rate would be 1/40 or 2.5% if the consumer was interested in seeing mortality for PE/DVT. If the 50 patients were in the hospital for a total of 200 days, the actual LOS would be 200/50 or 4.0 days.

In the indirect standardization approach, the benchmark for that physician on a given metric is calculated from the application of the benchmark for each specific patient based on that patient's APR-DRG or RDRG. These individual benchmarks are then summarized across that physician's patients into an overall expected or benchmark rate for that metric. The physician's actual performance is then compared against the benchmark or expected performance on each metric and can be expressed as a ratio. The various metrics can be combined and weighted to derive an overall ratio which can be used as the basis for ranking, network inclusion, pay-for-performance, or other initiatives.

The following example explains how the benchmarking is applied to patients and is calculated to come up with an overall benchmark for each category. In this example, Physician X treated 50 patients in two different case types. His actual mortality rate was 2 patients out of 50 or 4.0%. Looking at the benchmark for each of his patients as defined by case type and severity level, his expected mortality rate was 2.59% (see table below). These benchmarks can be based on the experience of patients nationwide or for a defined region for each case type and severity level. Physician X's performance ratio was therefore 2.59/4.00 or 0.65, where 1.00 would represent expected performance.

| Case | Severity | | Physician X | | |
|---|---|---|---|---|---|
| Type | Level | Benchmark | # Patients | Weight | |
| A | 1 | 0.30% | 5 | 0.03% | |
| A | 2 | 0.80% | 10 | 0.16% | |
| A | 3 | 2.00% | 5 | 0.20% | |
| A | 4 | 6.00% | 5 | 0.60% | |
| B | 1 | 0.50% | 0 | 0.00% | |
| B | 2 | 1.00% | 10 | 0.20% | |
| B | 3 | 3.00% | 10 | 0.60% | |
| B | 4 | 8.00% | 5 | 0.80% | |
| | | | 50 | 2.59% | Expected |
| | | | | 4.00% | Actual |
| | | | | 0.65 | Performance |
| | | | | | Ratio |

The table above illustrates how a benchmark can be calculated. A patient is assigned a case type. This case type can be based upon the illness, medical issue, or operation that patient came in for. The severity level is a ranking that describes the patient's risk of complications or other outcomes. For example, a patient with a higher severity level has a greater chance of passing away in the above example. The severity level has a corresponding mortality percentage for the defined area or sample size. This benchmark reflects actual mortality for the defined region, case type, and severity level of the patient. The benchmark is obtained by calculating the actual mortality rate for all patients that meet the case type and severity level definition in the geographic area of interest. The weight is obtained by dividing the number of patients for a benchmark (e.g., 5 for the first row) by the number of patients for Physician X (50). This ratio is used to modify the benchmark ( 5/50=0.1 and 0.30%*.1=0.03%). This modified number is the weight for Physician X because the benchmark is adjusted to account for the percentage of patients subject to that benchmark. If the number of patients is equal to zero, the weight is set to zero bypassing the calculation.

The weights are summed up for all the patients to obtain an expected percentage. A performance ratio, which is the expected percentage divided by the actual percentage, can also be displayed to help evaluate whether the physician's performance on a given metric is significantly different than the benchmark. If the performance ratio is above one, than the physician is performing better than expected. Otherwise, if the number is below one, then the physician is performing under what is expected.

In the direct standardization approach, the physicians are standardized according to an average physician. This allows meaningful comparisons between physicians at the metric level. For example, for the metric mortality rate, the mortality rate for each physician would be adjusted to look like the patient load an average physician would see. The algorithm to accomplish this would use a physician's actual mortality rate for each severity level and case type. This actual mortality rate is then multiplied by the percentage of patients that an average physician would treat in each of those severity levels and case types. This gives a number of weights which are added up and the summation is used to rank the physicians. The direct approach eliminates discrepancies, for example, between a physician who treats mostly high risk patients and a physician who treats mostly low risk patients. With no adjustment, the high risk patient physician may appear to have a higher mortality rate than the low risk patient physician, so a high risk patient might choose to see the low risk patient doctor, who in reality is not as good at treating high risk patients.

In addition to severity adjustment, consumer preferences are applied in an algorithm to determine ranking of physicians in the physician quality information system. Three ranking approaches are available for actual performance on a given measure—sequential ranking, quartile-based ranking, and summary ranking. As examples describe below, the physician performance rank is combined with the consumer preference weight for each measure to derive a category rank and/or an overall physician rank. Even under the direct severity adjustment approach the user may also be shown the actual mortality rate as well. In FIG. 5, the column “cases” shows the number of mortalities to the number of patients.

Under sequential ranking, the physician with the best performance on a given metric (e.g., patient volume, lowest mortality, lowest complication ratio, lowest LOS) is ranked #1, the next #2, etc., up to the number of physicians included in the comparison. If two physicians are tied, they both get the higher rank and the next physician is that rank+2 (e.g., two physicians rank #1 in mortality, next physician ranks #3 in mortality). The consumer's ranking for each metric is converted to a weight by summing all the rankings, then dividing each rank by the sum. For example, if the user ranks patient volume and mortality as Very Important (weight=3), complications as Somewhat Important (weight=2), LOS as Not Very Important (weight=1) and cost as Not at All Important (weight=0), the sum of the weights is 9 (3+3+2+1+0) and the weight of each factor is:

| | |
|---|---|
| Patient Volume | 3/9 = 33.3% |
| Mortality | 3/9 = 33.3% |
| Unfavorable Outcomes | 2/9 = 22.2% |
| Time | 1/9 = 11.1% |
| Money | 0/9 = 0 |

Given a list of physicians and their rankings (1st, 2nd, 3rd place, etc.), the weight for each evaluation measure is multiplied by the rank. The products of the metrics and the ranks are then added for each physician to obtain the weighted average rank. The physician with the lowest weighted average rank is the physician ranked 1st overall. For example, given three physicians and their ranks on the different measure:

| | Physician 1 | Physician 2 | Physician 3 |
|---|---|---|---|
| Patient Volume | 1 | 3 | 2 |
| Mortality Rate | 1 | 2 | 2 |
| Complications | 2 | 3 | 1 |
| LOS | 3 | 1 | 2 |
| Cost | 3 | 1 | 1 |

Using the weights calculated in the example above, each physician's rank on each factor is multiplied by the appropriate rank:

| | Physician 1 | Physician 2 | Physician 3 |
|---|---|---|---|
| Patient | 1 * 33.3% = .333 | 3 * 33.3% = 1.000 | 2 * 33.3% = .666 |
| Volume | | | |
| Mortality | 1 * 33.3% = .333 | 2 * 33.3% = .666 | 2 * 33.3% = .666 |
| Rate | | | |
| Compli- | 2 * 22.2% = .444 | 3 * 22.2% = .666 | 1 * 22.2% = *.222 |
| cations | | | |
| LOS | 3 * 11.1% = .333 | 1 * 11.1% = .111 | 2 * 11.1% = .222 |
| Cost | 3 * 0 = 0 | 1 * 0 = 0 | 1 * 0 = 0 |

The sum of these products is the weighted average rank:

| | Physician 1 | Physician 2 | Physician 3 |
|---|---|---|---|
| Weighted Average Rank | 1.443 | 2.443 | 1.776 |

Thus, Physician 1 is ranked 1st, and Physician 2 is ranked 3rd. Note that Physician 2 had as many 1st, 2nd, and 3rd places as Physician 1, yet ranked 3rd because it had 3rd places on evaluation measures which the consumer indicated as being more important.

Under quartile-based ranking, physicians are ranked based on the quartile they fall into for a given metric. The quartiles are based upon the physicians within the consumer-selected geographic area (the selected zip code or town and mileage). A 1st quartile ranking indicates best performance, while a 4th quartile ranking indicates the worst performance for each metric. If two or more physicians in the comparison are in the 1 st quartile, they are ranked #1. If no physicians in the comparison are in the 1 st quartile, no physicians are ranked #1.

The algorithm for computing the quartile rankings for a category ranking and/or an overall ranking is as follows: physician rank for specific metric (1, 2, 3 or 4, depending on quartile)* importance weight (3 for very important to 0 for no importance), summed across up to the number of metrics in the category (or number of categories for overall calculations), divided by the sum of the importance weights. For example, if the consumer ranked volume and mortality as very important (3), complications as somewhat important (2) and LOS and charges as not important (0) the sum of importance weights would be 3+3+2+0+0 or 8. If the physician was 1st quartile in volume, 2nd quartile in mortality and 2nd quartile in complications, the physician's overall index would be 1*3+2*3+2*2+0+0 or 10/8=1.25. The best possible index for a physician would be 1.0 (1st quartile on each measure), the worst 4.0 (4th quartile on each measure).

This calculation is performed for each physician the consumer selected for comparison (FIG. 3) and then the physicians are ranked based on the overall index (which is the same calculation, but performed at the category level instead of the metric level). The physician with the lowest index is ranked 1st, the next lowest 2nd, etc., through the number of physicians in the comparison.

The summary ranking is based on the quartile-based ranking described above, but differs in that physicians are grouped into three summary levels using easy to understand iconology. In the physician quality information system, the report displays the score icon 530 (FIG. 5) to indicate the quartile in which the physician falls. The top 25% physicians (1st quartile) are identified with a plus sign inside a circle, the middle 50% physicians (2nd and 3rd quartile) are identified with an empty circle, and bottom 25% physicians (4th quartile) are identified with a minus sign within the circle. This ranking display is visually appealing and easy for members and consumers to interpret at a glance.

A large number of quality metrics are available for use in the physician quality information system. These metrics are included in physician process performance measurements information and inpatient outcomes for a physician. The physician process performance measurements information is based on definitions developed by the Agency for Healthcare Research and Quality (AHRQ) in conjunction with the American Quality Alliance (AQA) and applied to the claims and/or public data for both the measurement of actual physician performance and the creation of quality benchmarks. AHRQ definitions are a set of performance measurements developed by physicians, health insurers, consumers, and others. Additional definitions outside the AHRQ list can also be used. However, because physician performance is being measured, the quality indicators are focused on those most influenced by the physician (i.e., physician-sensitive as opposed to nursing-sensitive metrics). A list of the AHRQ definitions is attached in Appendix A.

An example of quality metrics that can be used are: mortality rate (in-hospital mortality), failure to rescue rate, various physician-sensitive complications such as post-op PE/DVT, technical difficulty and OB trauma, and readmission rate within a defined period of time. Other metrics can be defined in the system depending on which metrics are most appropriate to use in terms of physician acceptance and meaningful benchmarks. Once the metric is defined, the quality rules engine 116 uses the definition to locate the appropriate data from claims and/or public data. Once this data is located, the data is compiled to develop benchmarks for the region. The benchmarks are calculated for each defined case type and severity of the patients based on the actual rates or numbers present in the patients in the region. Then severity adjustments of the physician metric data can be calculated.

Resource use metrics can also be displayed in the physician quality information system. The resource use metrics relate to the physician's impact on the use of hospital resources. Possible metrics include: length of stay (LOS)—as measured by average inpatient days in the hospital; intensive care unit (ICU) days—as measured by average inpatient days in the ICU; percentage of long LOS—percentage of patients exceeding an upper LOS threshold; percentage of short LOS—percentage of patients falling below a minimum LOS (potentially unnecessary admissions); and hospital cost—as measured by average hospital charges converted to costs using a ratio of costs to charges approach. These metrics can be supplemented with information on cost to the health plan for physician or hospital payments related to each patient, or other health plan provided information.

Patient satisfaction data that measures a patient's satisfaction with a physician's service can be displayed to the consumer as well as the performance and outcome information. The patient satisfaction data is compiled from a survey administered to patients receiving care. One patient satisfaction survey that can be used is developed by the United States Department of Health and Human Services in the Agency for Healthcare Research and Quality (AHRQ) and can be found in Appendix B. Other surveys having different questions can be used as well. The satisfaction metrics are compiled for each physician based on answers received from patients to question in the survey. A subset of the survey questions may be chosen for inclusion in the patient satisfaction category. The survey question answers received can be metrics used in the evaluation of the performance of physicians. The patient satisfaction metrics are calculated from a number of patient surveys of a physician and other parts of the survey information may be used to further quantify other survey responses. The patient satisfaction data can also be adjusted for severity and/or further refined. For example, a consumer could desire to see how other people in his or her age group felt about the physician. This information can be compared to how other physicians in the area faired on the same question. For example, patient satisfaction with a physician may be a 6.3 on a scale of 1 to 10 and this is compared to the average or median satisfaction among patients receiving care from the physicians the consumer is interested in comparing.

The benchmarks employed in the physician quality information system may be developed using external publicly available data or internal proprietary claims data. The advantages of public data are that the benchmarks are based on the relevant patients treated including a large percentage of the patients seen by a physician. This leads to robust benchmarks because the data is not limited to patients within particular insurance companies or health plans. The disadvantages are that the public data may not adequately reflect the book of business of a health plan that is looking to use this system for its customers. Additionally, the data tends to be 1 to 2 years older than claims data. The public data can be advantageously used for smaller regional health area physician comparison because the regional area may not have sufficient claims volume to develop robust benchmarks for all case types and severity levels. The physician quality information system may utilize national claims data to develop benchmarks because of the volume of claims data available. However, a variety of benchmarks can be developed depending on the consumer's preferences on whether benchmark data should be used and what types of benchmark data should be used (e.g., national benchmarks, regional benchmarks, consumer defined benchmarks).

There may be differences in the physician comparison reports generated by the physician quality information system depending on which benchmark is chosen to apply in the process. National benchmarks have the advantages of using very robust data for the development of the benchmarks and provide consistency with the approaches used across the board at hospitals. Regional benchmarks provide the ability to reflect regional differences in practice patterns. Providing reports for both national and regional benchmarks can illustrate the different bases used for benchmark determination. The physician quality information system can show how the region as a whole compares to the national benchmark. This approach puts an individual physician's performance into a regional as well as a national context.

In the physician quality information system, the robustness of the results depends on the number of claims and/or publicly available data for each physician. Greater numbers of data points generally produce more robust analysis and more statistically significant results. Physicians that do not have a certain amount of data available may be excluded from the analysis until enough data is available for the physician. Additionally, a consumer may select a threshold in the consumer preferences selection that determines how much data should be available to include a physician in the comparison process.

The physician quality information system can create benchmarks that are derived from average physician performance, top quartile performance, or other intermediate cutoff points. It can also identify a lower quartile benchmark to highlight physicians who may not meet a minimum level of performance. The consumer preferences can be used to allow the consumer to select the type of benchmarks that are used. The benchmarking selection may use cutoffs on the calculated performance ratio to highlight top quartile performance or other intermediate cutoff points. For example, the physician quality information system can determine the top quartile performance and highlight this group.

The physician quality information system maintains information at the individual attending or operating physician level regarding both actual performance and patient specific benchmarks. Individual physicians can be summarized into physician groups, networks or other combinations at any time. Statistical significance may be greater in comparing physician groups because of larger cell sizes (where cell size relates to the number of applicable patients). However, physician group comparisons may mask variations in individual physician performance and may not be as valuable to consumers as information at the individual physician level. The consumer can select these other types of comparisons in the consumer preference selection. In those instances, where the individual physician results do not meet a selected minimum cell size or statistical significance, the consumer may choose to display the physician group information instead of the individual physician information.

The physician quality information system identifies the attending physician, and where relevant, the operating physician for each inpatient admission in the database. In some instances, performance on quality and resource use metrics can be associated more directly to the relevant physician. For example, information being compiled can be associated with an operating physician in surgical cases, rather than to the attending physician when both may be linked to the same case. The consumer can decide whether to evaluate the performance of the operating physician for surgical cases, the attending physician for medical cases, or both concurrently. This provides the consumers flexibility to evaluate the quality of care that they can expect in a variety of circumstances.

The physician quality information system database 118 includes the inpatient claims and incorporates benchmarks for all types and severity levels of patients. However, those benchmarks may be applied to all of a physician's patients or just a subset (e.g., only general surgery patients or hip replacement patients or HMO patients). Narrowing the population on which a physician is benchmarked may lead to insufficient claim volume, but may be useful if targeted to a specific high volume case type (e.g., hip replacement or Coronary Artery Bypass Grafts (CABGs)). Because the data is included in the database, decisions regarding the relevant population can be made at any time by the consumer, if desired. The physician quality information system also allows a consumer to refine the benchmarking and rerun the results to see how the doctors perform in a specific operation.

The physician quality information system allows the determination of minimum case volume levels for the application of benchmarking. Since a benchmark is available for each individual patient a physician treats, these minimums relate to the number of patients of a physician for the population of interest (e.g., all patients treated by that physician, or all hip replacement patients for that physician). For example, the consumer can set the minimum volume at thirty for a physician's overall patient volume and at twenty for any narrower analysis related to an individual case type. If a physician does not meet the minimum, he or she may receive information on the physician group's performance.

Separate benchmarks can be developed by product (e.g., HMO, PPO, indemnity) or all products can be combined for the development of benchmarks. The product specific approach may be relevant if the covered populations are substantially different or if the user is focusing on a particular product. Narrowing the amount of data to just a single product line for developing the benchmarks may be problematic in terms of cell size issues. If overall benchmarks are developed, they may still be applied to each different product for reporting and for analysis purposes.

Benchmarks are typically developed for each severity level within each case type. If desired, the benchmarks can be segregated further by age and/or gender cohorts (e.g., age 50 to 65 for severity level 2 CHF patients). Because of the impact on cell size for the benchmark development, and the fact that the APR-DRG severity system takes into account age and gender, this additional refinement is often not necessary, but can be provided by the physician quality information system.

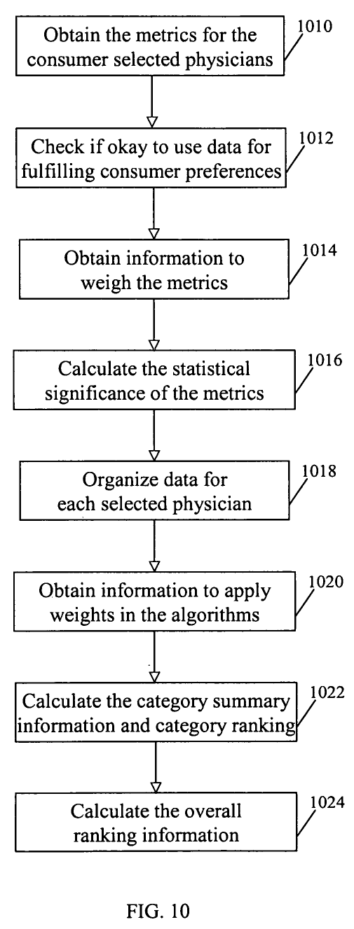

FIG. 10 illustrates an algorithm that can be used for obtaining a metric and how the rankings can be implemented in the physician quality information system. In step 1010, the metrics for the consumer selected physicians are obtained. This step can be triggered when the consumer clicks on compare selected button 320 (FIG. 3). The metrics are process performance metrics, outcome metrics, patient satisfaction metrics, or any other defined metrics for measuring physicians. The data in database 118 (FIG. 1) is checked in step 1012 to see if the data can be used to fulfill the consumer preferences for generating the report. This involves making sure the cell size is of sufficient size to provide meaningful information. In step 1014, the information to weight the metrics is obtained. This information includes the consumer preferences from, for example, FIG. 4 and other weights such as benchmark information. In step 1016, the statistical significance of the metrics is calculated (this is discussed further below).

The data for each physician that is available for comparison is organized in step 1018. This includes ranking and sorting the physicians for each metric. In step 1020, information is obtained to apply weights in the algorithms for category level summary ranking and overall summary ranking. The summary level ranking is calculated by applying a weight that corresponds to the consumer's preference for the metric and this weight is used to adjust the importance of the metric in relation to other metrics for the physician ranking (as described above). The adjusted metrics are summed up for each physician and this summation is used to rank and sort each physician in each category. The overall ranking in step 1024 can be calculated by using a weight with each category summation to determine an overall summation for each physician. The overall summation is used to rank the physicians in an overall summary level that can be based on the consumer's preferences.

The statistical significance calculations are used to indicate when a metric is significantly different from the area average mortality rate. The area average can be the consumer selected geographical area or can be defined by an administrator or other user. Statistical significance is calculated at a p value ranging from 0.20 (80% confident that difference is not due to chance) to 0.01 (99% confident that difference is not due to chance), depending on the choice of the administrator or other user. To compare a physician's adjusted mortality or complications metric, for example, to the comparison group of physicians' experience, the physician quality information system calculates each physician's standard deviation to convert that physician's average experience into a standard z-score. The physician quality information system then compares the physician's standard z-score to a z-score of the chosen confidence level (80% to 99% confident) to determine if each physician's experience is significantly above or below the area average.

To calculate each physician's z-score, the standard deviation for each physician is calculated first. The standard deviation measures the spread of normal data around the mean, that is, what differences from the mean are to be expected due to chance. For a binomial variable such as mortality, the equation for standard deviation (SD) is: SD2=p*(1−p)/n Where: p=Population Mean (the mortality rate of the physicians in the area) and n=Number of patients handled by the individual physician. Next, using each physician's standard deviation, another formula to is used calculate a z-score for each hospital: z=(x−μ)/SD2 Where: x=individual physician's average mortality (sample mean); μ=area physicians' average mortality (population mean); and SD2=individual physician's standard deviation (calculated above).

The z-score of the physician is compared to the z-score of the chosen confidence level. If the physician's z-score is greater than the z-score of the chosen confidence level, the physician's average is significantly greater than the average; if the physician's z score is less than the negative of the z-score of the confidence level, the physician's average is significantly less than the average.

The below example illustrates how statistical significance of a metric is calculated. The statistical significance is calculated using a chosen confidence level of 95% (z-confidence level=1.96) and the following data:

| Physician | Cases | Mortality | Significant |
|---|---|---|---|
| Physician #1 | 405 | 1.68% | Yes |
| Physician #2 | 219 | 4.24% | No |
| Physician #3 | 906 | 4.63% | No |
| Physician #4 | 688 | 5.17% | No |
| Average for Area Physicians | 226 | 5.59% | |
| Physician #5 | 267 | 5.86% | No |

Calculate each physician's standard deviation, given by SD2=avg(1−avg)/n and where SD is the square root of SD2:

note that: avg*(1−avg)=0.0559*(1−0.0559)=0.05277

SD2(P#1)=0.05277/405=0.0001303

SD(P#1)=0.0114

SD2(P#2)=0.05277/219=0.0002409

SD(P#2)=0.0155

SD2(P#3)=0.05277/906=0.00005825

SD(P#3)=0.00763

SD2(P#4)=0.05277/688=0.00007671

SD(P#4)=0.00876

SD2(P#5)=0.05277/267=0.0001977

SD(P#5)=.0.0141

Using the area average for the physicians and the individual physicians' standard deviation calculate the physician's standardized distance from the mean (z-score).

z(P#1)=(0.0168−0.0559)/0.0114=−3.43

z(P#2)=(0.0424−0.0559)/0.0155=−0.87

z(P#3)=(0.0463−0.0559)/0.00763=−1.25

z(P#4)=(0.0517−0.0559)/0.00876=−0.48

z(P#5)=(0.0586−0.0559)/0.0141=0.19

Notice that although physician #2's average is further from the mean than physician #3's, physician #2's standardized distance from the mean is smaller than physician #3's. This is because there were fewer patients handled by physician #2, and so there is less certainty of the difference. Comparing the physician's standardized distance to the z-confidence level to determine significance the following is ascertained: physician #1's standardized distance (z(physician #1)) is less than −1.96, and thus with 95% confidence the average is less than the overall area average. With the other physician z-scores between −1.96 and 1.96, a 95% confidence that the physician z-scores are different from average cannot be ascertained.

The above-mentioned algorithms can be used in the outcomes category to evaluate physicians on inpatient volume, mortality, physician sensitive complications, readmission rates, and length of stay after adjustment for severity. Quartiles are used to classify physicians into performance categories either at the individual procedure/diagnosis level, service line level, or across the physician's entire inpatient practice as desired. In the process performance category, algorithms employing definitions from the American Quality Alliance (AQA) (see Appendix A) regarding preventive care, diabetes care, coronary artery disease, depression and other outpatient areas of interest can be used. Quartiles can be used to classify physicians into performance categories across their entire practice. In the patient satisfaction category, algorithms using data collected from the proposed CMS survey instrument (see Appendix B) regarding patient satisfaction can be used. These surveys can be distributed on a website, in a physician's office, or through mail surveys. Quartiles will be used to classify physicians into performance categories across their entire practice.

At the category summary level, composite physician algorithms combine performance across the individual metrics within a given category (e.g., the outcomes category). These algorithms weight the importance of each individual metric in order to derive a composite performance score for that category. Overall physician performance algorithms combine performance scores across physician outcomes, performance, and satisfaction categories and adjust the categories by incorporating consumer preferences to rank the physicians. Each category is assigned a default weight based on consumer's or member's input, level of analysis (e.g., individual procedure vs. entire practice) and applicability of the data, and can be further adjusted to reflect consumer preference regarding importance.

Looking at FIG. 1, database 118 can be omitted and the data can be drawn directly from the data source databases. Additionally, more than one database 118 can be used. For example, one database can be used for each of patient satisfaction data, outcomes data, etc. The data source databases can be implemented on one or more computers and a hash table of the raw data can be used to provide quick access to the data. Other data sources may also be used in combination with the sources mentioned above, or in place of one or more of the data sources mentioned above. An example of other data sources that can be used are physician compliance with disease management, use of technology in a physician's office, and formulary compliance. The quality rules application engine can be used to load database 118 with information. In the physician quality website, the consumer can choose not to input any preferences, or only input a subset of the available preference choices. In this case, the weights can then be default weights chosen by the administrator, for example, a weight of 1. The navigation can also be accomplished by links, icons, split screens of frames, or any other applicable method. The physician ID can be a physician name. Further, an administrator or organization can define or redefine physician quality to meet their desires. This can involve specifying how the metrics are defined and what metrics are chosen for representation to consumers as well as what algorithms are chosen to adjust physician rankings such as the severity approach utilized.

Other embodiments are within the scope of the following claims.

### APPENDIX A

### Recommended Starter Set Clinical Performance Measures for Ambulatory Care

At the January 17^{th}-18^{th} meeting, the large stakeholder group directed the Performance Measurement Workgroup to propose a starter set of measures for ambulatory care, which align with agreed-upon parameters and address agreed-upon specific conditions/areas. The workgroup is recommending that the performance measures contained in this document serve as this starter set.
This recommendation was developed by the workgroup after significant discussion. The workgroup started with the “strawman” list of measures presented at the January meeting—all of which were part of the CMS-AMA Physician Consortium-NCQA ambulatory care performance measurement set that was submitted to NQF for expedited review. Utilizing a modified “Delphi” exercise to help facilitate the discussion, the workgroup considered and primarily selected measures based on their ability to meet the following criteria: (1) clinical importance and scientific validity; (2) feasibility; (3) relevance to physician performance; (4) consumer relevance; and (5) purchaser relevance. Other factors considered include whether measures were preliminarily approved by NQF's expedited review process and comments made during the last stakeholder meeting in January.
While the workgroup believes that this is a sound set of measures that meets primary goals, such as addressing the IOM's priority areas, they continue to recognize that this is an initial step in a multi-year process. Additional work needs to be done to build a more complete set of measures, which includes additional efficiency measures, sub-specialty measures, cross-cutting measures, patient experience measures and others.

| | |
|---|---|
| Prevention Measures | |
| 1. Breast Cancer | Percentage of women who had a mammogram during the measurement year |
| Screening | or year prior to the measurement year. |
| 2. Colorectal Cancer | The percentage of adults who had an appropriate screening for colorectal |
| Screening | cancer. |
| | One or more of the following: |
| | FOBT - during measurement year; |
| | Flexible sigmoidoscopy - during the measurement year or the four years |
| | prior to the measurement year; |
| | DCBE - during the measurement year or the four years prior; |
| | Colonoscopy - during the measurement or nine years prior. |
| 3. Cervical Cancer | Percentage of women who had one or more Pap tests during the |
| Screening | measurement year or the two prior years. |
| 4. Tobacco Use | Percentage of patients who were queried about tobacco use one or more |
| | times during the two-year measurement period. |
| 5. Advising Smokers to | Percentage of patients who received advice to quit smoking. |
| Quit | |
| 6. Influenza | Percentage of patients 50–64 who received an influenza vaccination. |
| Vaccination | Note: NQF also preliminarily approved this measure for patients 65 and |
| | older. |
| 7. Pneumonia | Percentage of patients who ever received a pneumococcal vaccine. |
| Vaccination | |
| Coronary Artery | |
| Disease (CAD) | |
| 8. Drug Therapy for | Percentage of patients with CAD who were prescribed a lipid-lowering |
| Lowering LDL | therapy (based on current ACC/AHA guidelines). |
| Cholesterol | |
| 9. Beta-Blocker | Percentage of patients hospitalized with acute myocardial infarction (AMI) |
| Treatment after | who received an ambulatory prescription for beta-blocker therapy (within 7 |
| Heart Attack | days discharge). |
| 10. Beta-Blocker | Percentage patients hospitalized with AMI who received persistent beta- |
| Therapy - Post MI | blocker treatment (6 months after discharge). |
| | Note: This measure was not reviewed by the NQF and therefore it is not |
| | approved |
| Heart Failure | |
| 11. ACE Inhibitor/ARB | Percentage of patients with heart failure who also have LVSD who were |
| Therapy | prescribed ACE inhibitor or ARB therapy. |
| | Angiotensin receptor blocker (ARB) drugs are collected under this measure. |
| 12. LVF Assessment | Percentage of patients with heart failure with quantitative or qualitative |
| | results of LVF assessment recorded. |
| Diabetes | Note: These measures were not approved during the NQF |
| | expedited review, as NQF has taken previous action on diabetes |
| | measures. |
| 13. HbA1C | Percentage of patients with diabetes with one or more A1C test(s) conducted |
| Management | during the measurement year. |
| 14. HbA1C | Percentage of patients with diabetes with most recent A1C level greater than |
| Management | 9.0% (poor control). |
| Control | |
| 15. Blood Pressure | Percentage of patients with diabetes who had their blood pressure |
| Management | documented in the past year less than 140/90 mm Hg. |
| 16. Lipid Measurement | Percentage of patients with diabetes with at least one Low Density |
| | Lipoprotein cholesterol (LDL-C) test (or ALL component tests). |
| 17. LDL Cholesterol | Percentage of patients with diabetes with most recent LDL-C less than 100 mg/dL |
| Level (<130 mg/dL) | or less than 130 mg/dL. |
| 18. Eye Exam | Percentage of patients who received a retinal or dilated eye exam by an eye |
| | care professional (optometrist or ophthalmologist) during the reporting year |
| | or during the prior year if patient is at low risk for retinopathy. |
| | A patient is considered low risk if all three of the following criteria are met: |
| | (1) the patient is not taking insulin; (2) has an A1C less than 8.0%; and (3) |
| | has no evidence of retinopathy in the prior year. |
| Asthma | |
| 19. Use of Appropriate | Percentage of individuals who were identified as having persistent asthma |
| Medications for | during the year prior to the measurement year and who were appropriately |
| People w/ Asthma | prescribed asthma medications (e.g. inhaled corticosteroids) during the |
| | measurement year |
| 20. Asthma: | Percentage of all individuals with mild, moderate, or severe persistent |
| Pharmacologic | asthma who were prescribed either the preferred long-term control |
| Therapy | medication (inhaled corticosteroid) or an acceptable alternative treatment. |
| Depression | |
| 21. Antidepressant | Acute Phase: Percentage of adults who were diagnosed with a new episode |
| Medication | of depression and treated with an antidepressant medication and remained on |
| Management | an antidepressant drug during the entire 84-day (12-week) Acute Treatment |
| | Phase. |
| 22. Antidepressant | Continuation Phase: Percentage of adults who were diagnosed with a new |
| Medication | episode of depression and treated with an antidepressant medication and |
| Management | remained on an antidepressant drug for at least 180 days (6 months). |
| Prenatal Care | |
| 23. Screening for | Percentage of patients who were screened for HIV infection during the first |
| Human | or second prenatal visit. |
| Immunodeficiency | |
| Virus | |
| 24. Anti-D Immune | Percentage of D (Rh) negative, unsensitized patients who received anti-D |
| Globulin | immune globulin at 26–30 weeks gestation. |
| Quality Measures | |
| Addressing Overuse or | |
| Misuse | |
| 25. Appropriate | Percentage of patients who were given a diagnosis of URI and were not |
| Treatment for | dispensed an antibiotic prescription on or 3 days after the episode date. |
| Children with Upper | |
| Respiratory | |
| Infection (URI) | |
| 26. Appropriate Testing | Percentage of patients who were diagnosed with pharyngitis, prescribed an |
| for Children with | antibiotic and who received a group A streptococcus test for the episode. |
| Pharyngitis | |

What is claimed is:

1. A method comprising:
obtaining from one or more data sources data about health care that was provided by a plurality of physicians;
from the data, computing a set of metrics for the plurality of physicians;
receiving preferences that are specified by a consumer, the preferences identifying physician attributes that are desired by the consumer;
deriving from the specified consumer preferences a set of weights for the set of metrics; and
for a group of physicians that is selected by the consumer from among the plurality of physicians, computing a ranking of those physicians based upon the computed set of metrics and the derived set of weights.

2. The method of claim 1, wherein obtaining from one or more data sources involves at least one of claims data, patient satisfaction data, and public discharge data.

3. The method of claim 1, further comprising:
applying the derived set of weights to a subset of metrics;
ranking the group of physicians based upon the subset of metrics and a derived subset of weights;
applying weights to a set of categories, wherein each category is the ranking of the group of physicians based upon the subset of metrics; and
ranking the physicians in an overall ranking based upon the set of categories.

4. The method of claim 1, wherein computing a set of metrics involves adjusting the metrics to account for severity.

5. The method of claim 1, further comprising:
calculating a benchmark for a selected geography; and
calculating a ratio of actual performance to benchmark performance for a metric.

6. The method of claim 1, further comprising:
checking data in at least one of claims data, patient satisfaction data, and public discharge data to determine if the data is acceptable for use in building a database; and
checking if the data includes information used for computing the set of metrics.

7. The method of claim 1, wherein computing a set of metrics involves using definitions for measuring physician performance provided by an association.

8. A method comprising:
receiving a consumer selection of a geographic location and at least one of a physician type and a medical procedure;
displaying a list of physicians based on the consumer selection;
receiving preferences that are specified by a consumer, the preferences identifying physician attributes that are desired by the consumer; and
for a group of physicians that is selected by the consumer from among the plurality of physicians, displaying a report that presents metrics on the group of physicians, presents a summary of a group of metrics in a category, and presents an overall ranking of the group of physicians customized to the preferences specified by the consumer.

9. The method of claim 8, further comprising:
calculating benchmarks based on the consumer preferences; and
displaying the group of physicians adjusted for severity based on a direct standardization approach.

10. The method of claim 9, further comprising:
adjusting the metrics on the group of physicians in relation to the benchmark information; and
displaying the overall ranking based on an indirect standardization approach.

11. The method of claim 8, wherein displaying a report involves displaying an overall ranking based on regional benchmarks.

12. The method of claim 8, wherein displaying a report involves at least one of displaying a report for at least one of a physician type and a medical procedure.

13. A system comprising:
a claims database and a public discharge database;
a quality rules application engine in communication with the claims database and the public discharge database, wherein the quality rules engine computes a set of metrics for the plurality of physicians;
a consumer preferences module that receives consumer preferences, the preferences identifying physician attributes that are desired by the consumer, and that derives from the specified consumer preferences a set of weights for the set of metrics; and
a physician quality website that displays a ranking of those physicians based upon the computed set of metrics and the derived set of weights for a group of physicians that is selected by the consumer from among the plurality of physicians.

14. The system of claim 13, further comprising:
a patient satisfaction database in communication with the quality rules engine; and
the quality rules engine determining a set of metrics for performance, outcome and satisfaction information from the claims database, the public discharge database, and the patient satisfaction database.

15. The system of claim 13, further comprising a metric weighting module that is in communication with the consumer preferences module and the physician quality website, wherein the metric weighting module applies severity adjustments and applies the set of weights to the set of metrics.

16. The system of claim 13, further comprising a database that is loaded with the set of metrics for the plurality of physicians.

17. The system of claim 13, wherein at least one of a new search, a change of physicians, and a change of consumer preferences links are provided to allow re-generation of the display of physician quality information.

18. A system comprising:
means for providing a data source;
means for providing an engine in communication with the means for providing a data source, wherein the means for providing an engine computes a set of metrics for the plurality of physicians;
consumer preferences means for receiving consumer preferences, the preferences identifying physician attributes that are desired by the consumer, and for deriving from the specified consumer preferences a set of weights for the set of metrics; and
means for displaying a ranking of those physicians based upon the computed set of metrics and the derived set of weights for a group of physicians that is selected by the consumer from among the plurality of physicians.

19. The system of claim 18, further comprising metric weighting means for applying severity adjustments and applies the set of weights to the set of metrics.
